(19) United States
(12) Patent Application Publication
(10) Pub. No.: US 2008/0276975 A1
(43) Pub. Date: Nov. 13, 2008

(54) Spray Nozzle For a Dishwasher

(75) Inventors: Harald Disch, Elzach (DE); Werner Neumaier, Offenburg (DE); Jurgen Litterst, Appenweier (DE); Gerhard Frei, Ohlsbach (DE)

Correspondence Address: THOMPSON HINE LLP;Intellectual Property Group, P.O Box 8801, DAYTON, OH, 45401-8801, US

(73) Assignee: PREMARK FEG L.L.C., Wilmington, DE (US)

(21) Appl. No.: 11/570,883

(22) PCT Filed: Jun. 17, 2005
(86) PCT No.: PCT/US2005/021835

§ 371 Date: Dec. 19, 2006

(30) Foreign Application Priority Data
Jun. 22, 2004 (DE) 10 2004 030 004.6

(51) Int. Cl. A47L 15/16; A47L 15/23; B05B 1/14

(52) U.S. Cl. 134/176; 134/198; 239/550

(57) ABSTRACT

A dishwasher (60) spray nozzle (20) is arranged on an outer surface (34) of a spray system (22) for discharging a spray jet (28). The outlet opening of the spray nozzle (20) has a constriction (26, 40) in a central region of its longitudinal extent.

### TECHNICAL FIELD

This application relates to a spray nozzle for a dishwasher.

### BACKGROUND

Dishwashers with spray nozzles for spraying dishwashing agent solution and/or rinsing aid solution are known from the art. A dishwasher may be a commercial dishwasher or a domestic dishwasher. Known commercial dishwashers are hand-loaded programmable machines and dishwashers with conveying systems.

Dishwashers of this type include a washing system with at least one spraying system, which has a number of spray nozzles, for spraying liquid, for example washing liquid such as dishwashing agent solution or rinsing liquid such as rinsing agent solution, onto items to be washed, for example dishes to be washed. A spraying system may be movable, for example formed by a rotatable spray arm, as is known from hand-loaded programmable machines and domestic dishwashers. A spraying system may also be fixedly installed in the dishwasher, as is customary in the case of dishwashers with a conveying system.

There are known dishwashers which use the same spraying systems for spraying the rinsing liquid as are used for spraying the washing liquid. Furthermore, there are known programmable machines and conveyor-type dishwashers which use separate spraying systems for spraying the rinsing liquid and the washing liquid. The washing liquid is generally in a tank which is arranged in such a way that it collects washing liquid running off the dishes and, depending on the type of dishwasher, also rinsing liquid running off the dishes. From the tank, the washing liquid or the rinsing liquid is pumped to the at least one spraying system and sprayed onto the dishes by the spray nozzles of the spraying system.

The washing liquid may generally contain essentially water, to which a surfactant, alkaline dishwashing agent is added. The rinsing liquid generally contains essentially water without anything added or with rinsing agent added.

Spraying systems of a dishwasher which contain spray nozzles with the form of a slot are known from the art. The spray nozzles are in this case arranged in a depression on the outer surface of a spray tube. The depression reduces the risk of the spray nozzle becoming clogged, since the depression reduces the cross section for the liquid flowing in the spray tube, which in turn increases the flow rate of the liquid in the region of the depression. Furthermore, the depression brings about a fanning out of the spray jet, turned by 90° , with respect to the longitudinal extent of the spray nozzle.

The inventors have found that, in the case of this slot form of nozzle, an undesired accumulation of liquid occurs at the lateral edges of the spray jet. The inventors have also found that, in the case of known slot nozzles, a breaking away of the initially continuous spray jet takes place and drop formation commences already at a short distance from the spray nozzle.

The formation of drops when the continuous liquid film breaks away produces a very large surface area of the liquid, whereby considerable amounts of energy are given off to the ambient air before the liquid hits the items to be washed. The development of steam is also much greater in the case of a large surface area than in the case of a continuous liquid film. Furthermore, the great curvature of the surface of the drops leads to an increased rate of evaporation of liquid. The energy given off to the ambient air must be replenished if the liquid is circulated.

Apart from the washing time, the temperature and the concentration of dishwashing detergent in the washing liquid, the washing quality of dishwashers is also determined by the delivery of said washing liquid to the items to be washed. According to the findings of the inventors, it is desirable to achieve a liquid distribution that is as uniform as possible not just over the useful width of the machine, but also from each individual spray nozzle.

It would be desirable to provide a spray nozzle which provides in a simple way a high jet quality of the liquid jet delivered by the spray nozzle.

### SUMMARY

According to one aspect, the outlet opening of a spray nozzle of a dishwasher is arranged in a depression on the outer surface of a spraying system for the delivery of a spray jet or of the nozzle itself. The spray nozzle is of an elongate formation and has a constriction in a middle region of its longitudinal extent.

It has surprisingly been found by the inventors that there is all the more liquid in a jet centre of the spray jet, the greater the constriction is. The liquid distribution in the case of a spray nozzle according to the invention is more uniform than in the case of a known slot nozzle. Furthermore, in the case of the liquid jet produced by the spray nozzle, the form of nozzle according to the invention surprisingly results in a very long region of a continuous liquid film before this liquid film breaks away and forms drops far away from the spray nozzle.

The greatly extended region of the continuous liquid film brings about a significant energy saving in comparison with known forms of nozzle. It also achieves the effect that the liquid film reaches as far as the items to be washed. In this way, washing liquid is specifically directed onto the items to be washed, which is not the case when there is uncontrollable drop formation, as occurs in the case of the spray nozzles known from the art.

The spraying system may be intended for the delivery of any desired liquids that are used in a dishwasher, for example for the exclusive spraying of washing liquid, for the exclusive spraying of rinsing liquid or for the spraying of both washing liquid and rinsing liquid.

The exact form of nozzle and the nozzle dimensions can be adapted to the actual requirements.

The spray nozzle preferably has the form of an “8” or what may be referred to as a “dogbone” configuration. On account of its simple form, this form of nozzle can be produced with similarly little expenditure as a slot nozzle.

The ratio of the width of the constriction to the width of the nozzle ends determines the amount of water at the centre of the spray jet in relation to the amount of water at the edges of the jet. A width of the constriction is preferably 0.3 to 0.7 times, for example half, the width of the spray nozzle. With this width ratio, a very uniform liquid distribution was found in tests.

If the ratio of the width of the constriction to the width of the spray nozzle is made small enough, there is an accumulation of liquid at the centre of the jet. In tests, this was found for example with a nozzle width of 4 mm and a width of the constriction of 1 mm.

The form of the nozzle may be made up of basic geometrical shapes. For example, the nozzle ends and the region of the constriction may be respectively based on simple basic geometrical shapes. A simple basic geometrical shape may be, for example, a rectangle, a square, a circle, a triangle, a trapezium, etc.

For example, the constriction may be of rectangular formation. The form of nozzle may then be designed as follows: the nozzle ends are chosen to be of the form desired, for example a circular form, and to have a desired distance, which determines the length of the nozzle. Subsequently, the nozzle ends are “joined” by a rectangle of a desired width, for example the width of the constriction. The basic forms adjoining or overlapping one another in this case form the desired form of nozzle in their overall outline.

Joints at which the individual basic forms adjoin one another may be rounded off. The rounding off of joints reduces vortexes in the spray jet, which may lead to breaking away of the liquid film, and therefore improves the quality of the jet.

When adapting the form and the dimensions of the spray nozzle, the arrangement and number of the spray nozzles on the spray tube should be taken into account. If the spray nozzles are arranged in such a way that the spray jets delivered by them are in line and, in addition, the number of spray nozzles is so high that their spray jets overlap in their lateral edges before they hit the items to be washed, the constriction is preferably made greater, so that each individual spray jet itself has a certain accumulation of liquid at the centre of the spray jet. The overlapping of the lateral edges of the individual spray jets achieves the effect in the combination of all the spray jets together of a uniform distribution of liquid over the spray tube.

According to one embodiment, the spray jet is formed as a separate part for insertion in the spraying system. For this purpose, the spray nozzle may be formed for example as a moulding of plastic. According to another embodiment, the spray nozzle is incorporated in the spraying system. For example, the spray nozzle may be punched into a spray tube or a spray arm.

The depression may have the form of a spherical cap, which may for example be hemispherically formed. Furthermore, the spherical cap may comprise a segment of a sphere which is larger or smaller than a hemisphere. The depression of the spraying system may also have a form other than that of a spherical cap. For example, the depression may be of a part-ellipsoidal, parabolic or similar formation. The depression may also be formed as a groove or channel with a round cross section. The longitudinal direction of the spray nozzle is in this case preferably arranged such that it is inclined, for example turned by 90 degrees, in relation to the longitudinal direction of the groove.

Each depression may have a single spray nozzle. It may alternatively be provided that at least some of the depressions have two or more spray nozzles.

The flow pressure with which the spray nozzle is operated preferably lies in customary pressure ranges. For example, the flow pressure may lie between 0.1 and 1 bar. In particular in the case of a nozzle length of 10 mm, a width of the spray nozzle of 4 mm and a width of the constriction of 2 mm, good results were achieved in tests at a flow pressure in the range between 0.2 and 0.7 bar.

### BRIEF DESCRIPTION OF THE DRAWINGS

FIG. 1 shows a spray nozzle known from the prior art;

FIG. 2 schematically shows the liquid distribution of a spray jet delivered by the spray nozzle from FIG. 1;

FIG. 3 shows an embodiment of a spray nozzle according to the invention;

FIG. 4 schematically shows the liquid distribution of a spray jet delivered by the spray nozzle from FIG. 3;

FIG. 5 shows a cross section through the spray nozzle from FIG. 3;

FIG. 6 shows a spray nozzle with a greater constriction than that of FIG. 3;

FIG. 7 schematically shows the liquid distribution of a spray jet delivered by the spray nozzle from FIG. 6;

FIG. 8 shows a further embodiment of a spray nozzle according to the invention;

FIG. 9 shows yet another embodiment of a spray nozzle according to the invention;

FIG. 10 shows an embodiment of a dishwasher according to the invention;

FIG. 11 shows an embodiment of a spraying system according to the invention;

FIG. 12 shows a cross section through the spraying system from FIG. 11.

### DETAILED DESCRIPTION

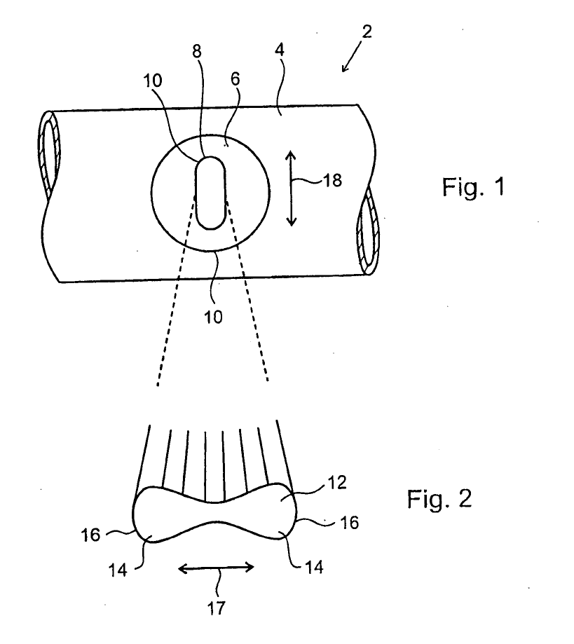

FIG. 1 shows a portion of a spray tube 2, known from the prior art, which has on its outer surface 4 a depression 6 in which a slot nozzle 8 is arranged. The slot nozzle 8 has a constant nozzle width into the radii at the nozzle ends 10 and produces a spray jet 12, which has an accumulation of liquid 14 at the edges of the jet 16, as represented in FIG. 2. The liquid distribution of the spray jet 12 delivered by the known spray nozzle 2 is consequently not uniform along the spray jet 12. A longitudinal extent 17 of the spray jet 12 is turned through 90 degrees with respect to a longitudinal extent 18 of the slot nozzle 8, which the dashed lines between FIG. 1 and FIG. 2 illustrate.

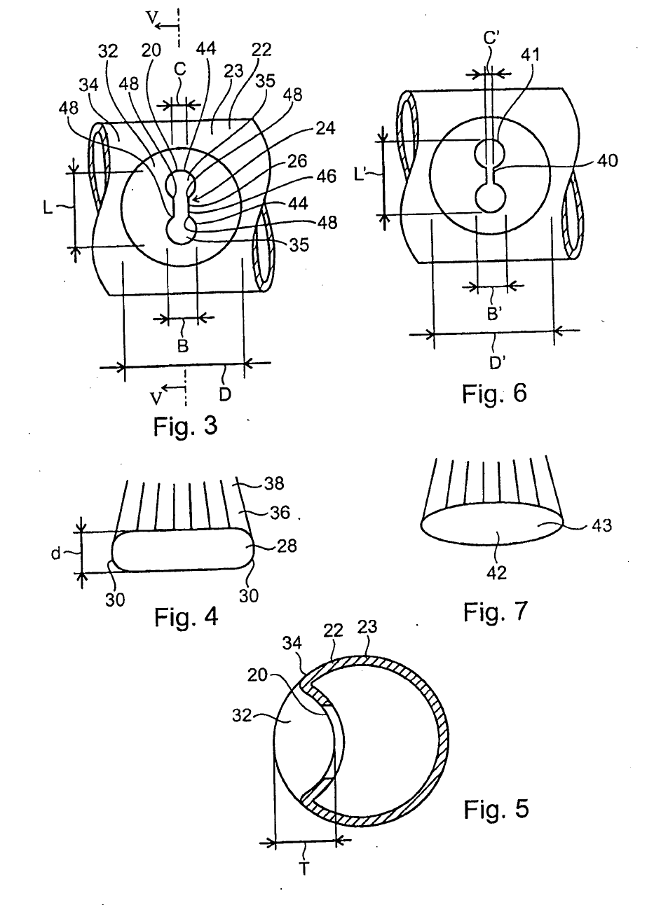

As represented in particular in FIG. 3, by contrast with this, a spray nozzle 20 of a spraying system 22 according to the invention, here a spray tube 23, has a constriction 26 in a middle region 24 of its longitudinal extent, so that the spray jet 28 delivered by the spray nozzle 20 has a more uniform liquid distribution. As represented in FIG. 4, the spray jet 28 consequently may take the form of a film with a substantially uniform thickness d. Only in the outermost edges of the jet 30 is there an unavoidable deviation, caused by the surface tension of the washing liquid.

As represented in FIG. 3 and FIG. 5, the spray nozzle 20 is arranged in a hemispherically formed depression 32 on an outer surface 34 of the spray tube 23. The depression 32 has a diameter D=16 mm. A depth T of the depression 32 is T=7 mm. The spray nozzle 20 represented in FIG. 3 has the preferred form of an “8”. This spray nozzle 20 has circular nozzle ends 35, between which a rectangular constriction 26 extends. The spray nozzle 20 represented has a width B=4 mm with a width C=2 mm of the constriction 26. The nozzle length L is 10 mm. These dimensions produce a spray jet 28 which has a fairly uniform liquid distribution into the roundings of the edges of the jet 30, as represented in FIG. 4. The flow pressure of the liquid was in this case between 0.2 and 0.7 bar.

The uniform liquid distribution achieves the effect of a long region 36 of a continuous liquid film 38 in the direction of flow of the spray jet 28, drop formation only taking place far away from the spray nozzle 20, so that the liquid film 38 reaches up to an item to be washed 39. In this way, washing liquid is directed specifically onto the item to be washed 39.

If the width C′ of a constriction 40 in relation to a width B′ of a spray nozzle 41 is made small enough, as represented in FIG. 6, an accumulation of liquid takes place in the jet centre 42 of the spray jet 43 delivered by the spray nozzle 41 (FIG. 7). This occurs for example if in the case of the form of nozzle in FIG. 6, with otherwise the same dimensions as in FIG. 3 (L′=L, B′=B, D′=D), a width of the constriction 40 of C′=1 mm is chosen instead of C=2 mm, as in the embodiment represented in FIG. 3.

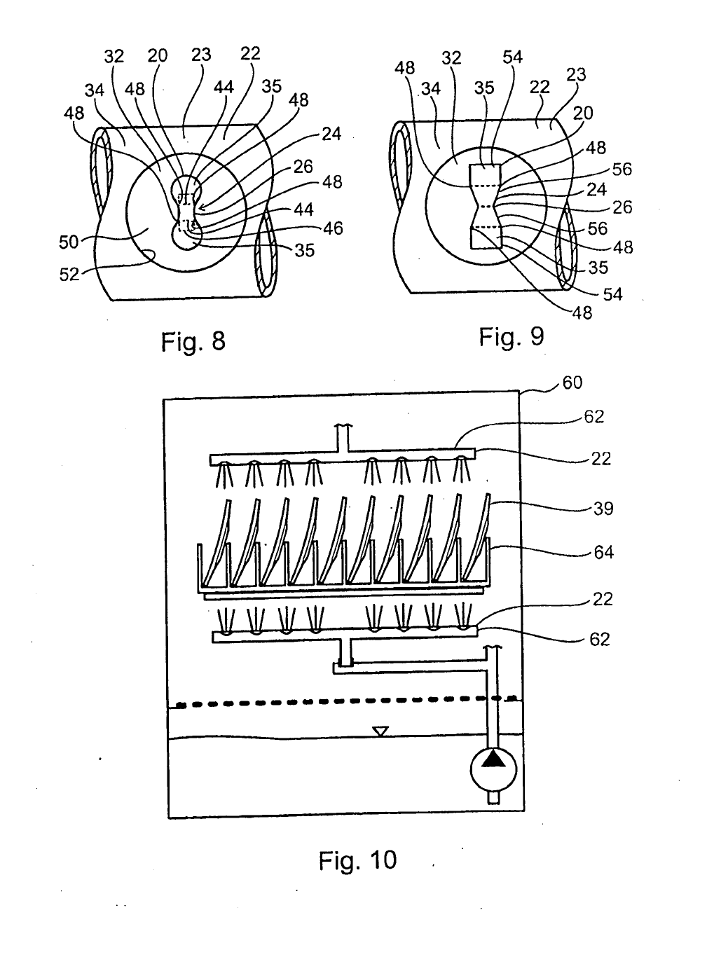

The spray nozzle 20 represented in FIG. 3 and FIG. 8 may be made up of basic geometrical shapes, that is of two circles 44 and a rectangle 46. In FIG. 8, the entire peripheral line of the basic geometrical shapes is depicted by dashed lines. It must be emphasized that the peripheral lines, represented by dashed lines, of the basic geometrical shapes serve only to illustrate one possible design principle for the construction of the form of nozzle and no longer appear on the spray nozzle 20 formed in the spray tube 23; rather, the form of nozzle of the spray nozzle 20 here is the envelope of the individual basic forms.

In the case of the spray nozzle 20 represented in FIG. 3, there is a point at the joints 48 at which the circles 44 adjoin the rectangle 46. Since points in the form of nozzle possibly impair the quality of the spray jet 28, the joints 48 may be rounded off, as is represented in FIG. 8, so that the form of nozzle deviates here from the envelope of the basic geometrical shapes.

The spray nozzle 20 represented in FIG. 8 is formed as a separate part 50, which is inserted into a bore 52 in the spray tube 23. FIG. 9 shows a further spray nozzle 20, based on basic geometrical shapes. The nozzle ends 35 are formed here by rectangles 54, while the constriction 26 is formed by two trapeziums 56. FIG. 10 shows a programmable machine 60 with spraying systems 22. The spraying systems 22 are formed in FIG. 10 as rotatable spray arms 62, which are located above and below a rack 64, in which the items to be cleaned 39 are arranged. The spray arms 62 are provided in order to spray a washing liquid onto the items to be cleaned 39 in a washing cycle. After the washing cycle, the spray arms 62 spray rinsing liquid onto the items to be washed 39.

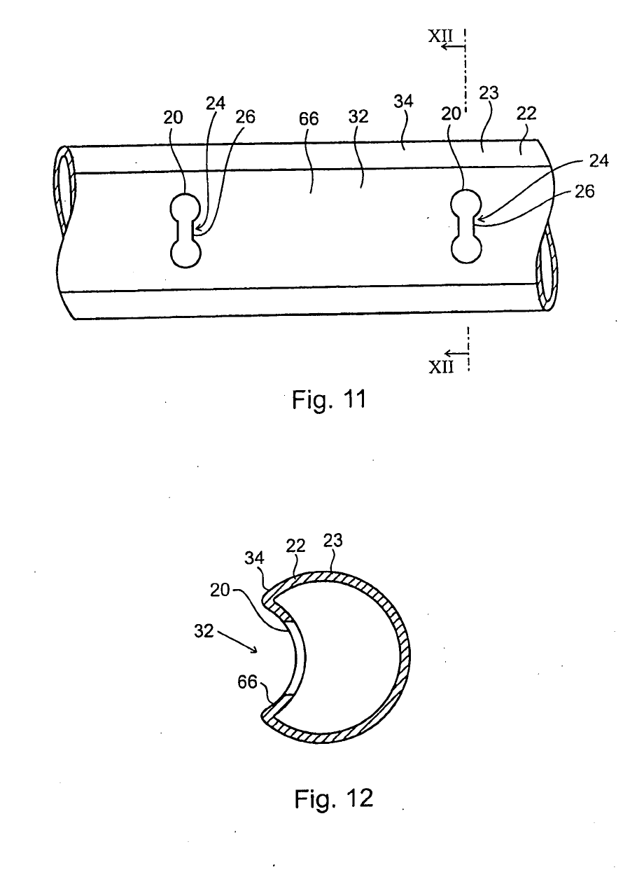

FIG. 11 shows an alternative embodiment of a spray tube 23, in which the depression is formed as a longitudinal groove 66. The portion represented of the spray tube 23 has two spray nozzles 20. In this embodiment, the spray nozzles 20 are incorporated in the spray tube 23, for example punched or milled. The longitudinal extent of the spray nozzles 20 is turned through 90 degrees with respect to the longitudinal extent of the longitudinal groove.

The longitudinal groove 66 has a rounded, part-circular cross section, as represented in FIG. 12.

The invention is not restricted to the embodiments of FIG. 3 to FIG. 12, shown by way of example in the drawings. Rather, the invention is obtained by overall consideration by a person skilled in the art of the claims, the description, the embodiments that are provided by way of example and the variants mentioned below, which are intended to give a person skilled in the art suggestions for further possible embodiments, without restricting the possibilities of variation to these suggestions.

As far as the form of nozzle is concerned, a form of nozzle similar to that represented in FIG. 3 and FIG. 8 appears to be particularly advantageous. In particular, it is possible for nozzles to take a form somewhere between the forms represented in FIG. 3 and FIG. 8 by way of example. A combination of individual nozzle sections of the forms of nozzle represented by way of example is possible, the advantages according to the invention also being obtained for the resulting forms of nozzles. In particular, it is possible to combine the represented forms of the nozzle ends 35 in any way desired with the represented forms of the middle region 24 between the nozzle ends 35.

As far as the cross section of the spraying system 22 is concerned, cross-sectional forms other than the round cross-sectional form represented in FIG. 5 are possible, for example ellipsoidal or rectangular cross-sectional forms.

In the case of the programmable machine 60 in FIG. 10, two rotatable spray arms 62 may be respectively provided above and below the rack 64, one for dishwashing agent solution and one for rinsing aid solution. As a departure from the programmable machine 60 represented in FIG. 10, a dishwasher may also have a conveying system. In particular in this case, at least part of the spraying systems present in the dishwasher may be fixedly installed.

We claim:

1. A dishwasher spray nozzle that is arranged on an outer surface of a spray system for discharging a spray jet, the spray nozzles includes an outlet opening that is of elongate formation, characterized in that the outlet opening has a constriction in a central region of a longitudinal extent of the outlet opening.

2. The spray nozzle according to claim 1, characterized in that the outlet opening of the spray nozzle is arranged in a depression.

3. The spray nozzle according to claim 2, characterized in that the depression is essentially of domed form.

4. The spray nozzle according to claim 2, characterized in that the depression is designed as a groove of rounded cross section, and the longitudinal direction of the spray nozzle is inclined in relation to the longitudinal direction of the groove.

5. The spray nozzle according to claim 1, characterized in that the outlet opening is essentially in the form of an “8”.

6. The spray nozzle according to claim 5, characterized in that a width of the constriction is 0.3 to 0.7 times a maximum width of the outlet opening.

7. The spray nozzle according to claim 1, characterized in that the outlet opening is rectangular in the region of its constriction.

8. The spray nozzle according to claim 1, characterized in that it is configured as a separate plastic moulded part that is inserted into the spray system.

9. The spray nozzle according to claim 1, characterized in that it is unitary with the spray system.

10. A dishwasher including a plurality of spray nozzles in accordance with claim 1.

11. The dishwasher of claim 10, characterized by the spray system includes a spray tube or as a spray arm with which the plurality of spray nozzles are associated.

12. A dishwasher including at least one elongated member through which a liquid flows for ejection through a plurality of spray nozzles located on the elongated member, each spray nozzle includes an elongated outlet opening with a constriction in a central region of a longitudinal extent of the outlet opening.

13. The dishwasher of claim 12 wherein the elongated member comprises an arm mounted for rotation within the dishwasher.

14. The dishwasher of claim 12 wherein the elongated member comprises a stationary tube.

15. The dishwasher of claim 12 wherein the outlet opening of each spray nozzle is essentially in the form of an “8”.

16. The dishwasher of claim 12 wherein each spray nozzle is formed unitary with the elongated member.

17. The dishwasher of claim 12 wherein each spray nozzle is formed as a moulded plastic part that is connected to the elongated member.
